(19) United States
(12) Patent Application Publication
(10) Pub. No.: US 2013/0030759 A1
(43) Pub. Date: Jan. 31, 2013

(54) SMOOTHING A TIME SERIES DATA SET WHILE PRESERVING PEAK AND/OR TROUGH DATA POINTS

(71) Applicants: Ming C. Hao, Palo Alto, CA (US); Umeshwar Dayal, Saratoga, CA (US); Walter Hill, Mettmann (DE); Sebastian Mittelstaedt, Konstanz (DE); Halldor Janetzko, Konstanz (DE)

(72) Inventors: Ming C. Hao, Palo Alto, CA (US); Umeshwar Dayal, Saratoga, CA (US); Walter Hill, Mettmann (DE); Sebastian Mittelstaedt, Konstanz (DE); Halldor Janetzko, Konstanz (DE)

(21) Appl. No.: 13/190,567

(22) Filed: Jul. 26, 2011

(51) Int. Cl. G06F 17/18

(52) U.S. Cl. 702/179

(57) ABSTRACT

Implementations disclosed herein relate to smoothing a time series data set while preserving at least one of peak or trough data points. In one embodiment, a processor recursively identifies at least one of a peak or trough point outside of a threshold distance from a connecting line connecting a beginning and ending point within the time series data set.

### BACKGROUND

A time series data set may include data captured at different points in time. For example, for an information technology system, the number of user of the system may be captured each hour. The time series data may be used to predict events at future points in time. Before a prediction method is executed using the time series data, the time series data set may be smoothed such that it contains fewer data points for analysis.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of an electronic device.

FIG. 2 is a flow chart illustrating one example of a method to smooth a time series data line.

FIG. 3 is a diagram illustrating one example of smoothing a time series data line while preserving peak and trough points.

FIGS. 4A and 4B are diagrams illustrating examples of smoothing a time series data line using different threshold distances.

### DETAILED DESCRIPTION

A time series data set may be used to predict the likelihood of a future event. The time series data set may include data captured at specific points in time, and the likelihood of a future event occurring at a future point in time may be determined by analyzing the time series data set. A time series data set may be smoothed in order to remove measurement errors, such as noise. For example, some of the data points in the time series data set may be averaged or otherwise combined to result in a trend line with fewer changes in direction than the original time series data set. In some cases, smoothing the data may result in peaks and troughs in the data set being removed, such as where the peak and trough data is averaged with other data. As a result, a prediction method may be run on a data set without peak and trough information. In some contexts, such as where a prediction method is run on an information technology system data set, a prediction made without consideration of peak and trough data may be unreliable. For example, a data set of power consumption data of a system that does not include peak power consumption information may lead to a misleading prediction, and the available amount of power in the future may be lower than the peak power consumption, leading to a system failure.

To address these issues, a time series data set may be smoothed while preserving peak and/or trough data points. In one implementation, a processor recursively creates a connecting line between two data points within the time series data set and identifies a peak and/or trough point outside of a threshold distance from the connecting line. The identified point outside of the threshold distance from the connecting line may be preserved when smoothing the data set. The threshold distance may be set by a user. The threshold distance may be changed to change the amount of smoothing of the time series data set. For example, a larger threshold distance may result in fewer peak and/or trough points outside of the threshold distance. A new trend line may be created that includes the identified peak and/or trough points. In some implementations, the new trend line may be used in a prediction method.

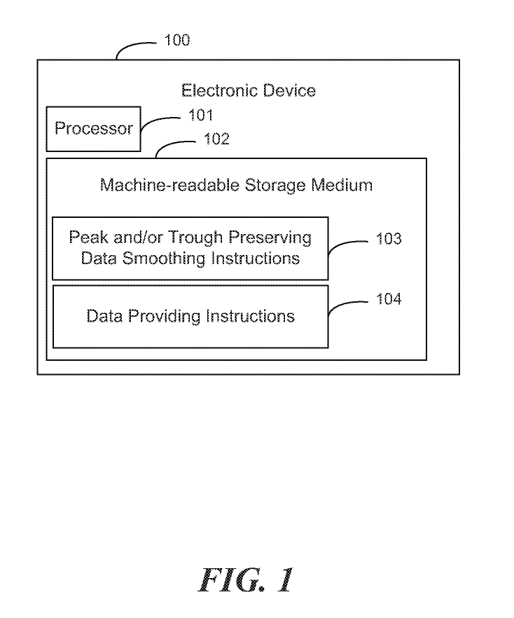

FIG. 1 is a block diagram illustrating one example of an electronic device 100. The electronic device 100 may be used to smooth a data set of time series data while preserving peak and trough data points. The electronic device 100 may include a processor 101 and a machine-readable storage medium 102.

The processor 101 may be any suitable processor, such as a central processing unit (CPU), a semiconductor-based microprocessor, or any other device suitable for retrieval and execution of instructions. In one implementation, the electronic device 100 includes logic instead of or in addition to the processor 101. As an alternative or in addition to fetching, decoding, and executing instructions, the processor 101 may include one or more integrated circuits (ICs) (e.g., an application specific integrated circuit (ASIC)) or other electronic circuits that comprise a plurality of electronic components for performing the functionality described below. In one implementation, the electronic device 100 includes multiple processors. For example, one processor may perform some functionality and another processor may perform other functionality described below.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101.

The machine-readable storage medium 102 may include peak and/or trough preserving data smoothing instructions 103 and data providing instructions 104. The peak and/or trough data smoothing instructions 103 may include instructions for smoothing a time series data set to preserve points outside of a threshold distance from a line connecting data points within the time series data set. For example, a portion of the time series data may be selected for smoothing, and two points within the selected portion may be connected with a connecting line, such as the first and last point within the selected portion. Points outside of a threshold distance from the connecting line may be preserved when smoothing the data set. Peak, trough, or peak and trough points outside of the threshold distance from the connecting line may be included in an updated trend line of the time series data set. In some cases, the process may be repeated recursively.

As an example, the peak and/or trough data smoothing instructions 103 may include instructions to create a first connecting line between a point A and point Z in a time series data set. A point D may be identified as the point between the point A and point Z that is the peak outside of the threshold distance from the first connecting line. The processor may then draw a second connecting line between point A and point D and a third connecting line between point D and point Z. A point C may be identified between point A and point D as the trough point outside of the threshold distance from the second connecting line, and a point F may be identified between point D and point Z as a peak outside of the threshold distance from the third connecting line. The processor may determine that there are no points outside of a threshold distance from a fourth line connecting point A and point C, from a fifth line connecting point C and point D, from a sixth line connecting point D and point F, and from a seventh line connecting point F and point Z. The processor may then create the smoothed time series trend line by connecting data points A, C, D, F, and Z.

The data providing instructions 104 may include instructions for providing the smoothed trend line. For example, the smoothed trend line may be displayed, stored, or transmitted. The data providing instructions 104 may provide instructions to cause the smoothed trend line to be displayed on a display associated with the electronic device 100 or a display associated with another electronic device. In some cases, the provided smoothed trend line may be used for further analysis. For example, the data set may include data collected from an information technology system, and a prediction method may be run on the smoothed data set. The likelihood of a future event may be calculated using the smoothed trend line.

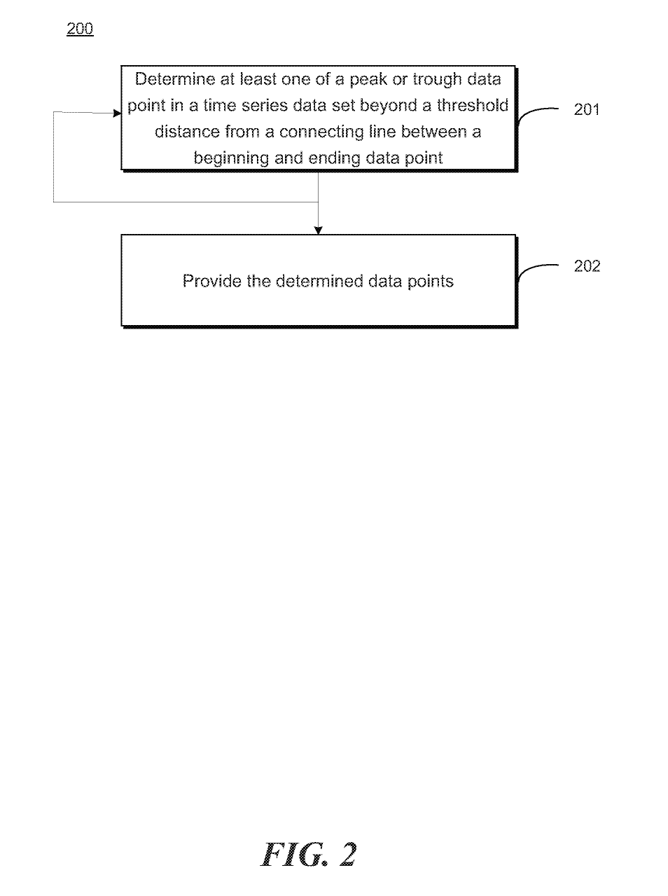

FIG. 2 is a flow chart 200 illustrating one example of a method to smooth a time series data line. For example, a processor may smooth a time series data set while preserving some peak and/or trough points. The processor may recursively analyze portions of the time series data set to find peak and/or trough points in each portion for preserving. In one implementation, the processor, creates a connecting line between two points in the time series data set and determines a point between the two points that is a peak or trough outside of a threshold distance from the connecting line. The method may be performed recursively such theta new connecting line is created between a different set of points. For example, a peak or trough point outside the connecting line between the new set of points is determined. The identified peak and/or trough points may be preserved when smoothing the time series data set. The method may be implemented, for example, by the electronic device 100.

Beginning at 201, a processor determines at least one of a peak or trough data point in a time series data set beyond a threshold distance from a connecting line between a beginning and ending data point. The processor may be a Central Processing Unit (CPU) or other type of processor. The processor may be the processor 101 from FIG. 1. The time series data set may be any set of ordered data based on time. The time series data set may represent data related to an information technology system. For example, the time series data set may represent an amount of power consumption, a number of users, or a number of times an application is accessed over a period of time for a web-based service.

The connecting line may be created such that a threshold distance from the connecting line may be used to identify points to be preserved when smoothing the time series data. The connecting line may be created between any suitable two points. For example, a beginning and ending point may in some cases be selected by a user where a user would like the portion of the time series data between the selected points to be smoothed. In some cases, the processor may select the beginning and ending point, such as where the beginning and ending point of the entire data set are automatically selected or where portions of the time series data net with a particular level of volatility are selected. The connecting line may be a straight line connecting the two points.

The threshold distance may be any suitable distance from the connecting line. The threshold distance may represent a distance above, below, or above and below the connecting line. For example, in some cases a user may find peak data to be useful, but may be uninterested in trough data. In some cases, it may be useful to preserve both peak and trough data. In some cases, a threshold distance above the connecting line may be a different distance than a threshold distance below the connecting line.

The processor may calculate the threshold distance based on user input. For example, user input may indicate that ten percent of the data points should be smoothed, and the processor may determine a threshold distance for achieving the desired result. In some implementations, a user may indicate a threshold distance. For example, for a time series data net of a number of users at different points of time, the threshold distance may be 1.5 users above or below the connecting line. In one implementation, the threshold distance may be automatically determined by the processor. For example, the processor may choose a threshold distance based on stored information about the user's preferences.

The processor may recursively determine points beyond the threshold distance from the connecting line in any suitable manner. For example, after identifying a peak or trough data point, the method may continue to repeat the step 201 using different beginning or ending data points. The processor may determine a peak or trough point outside of the threshold distance from the connecting line. The user may indicate whether peak points, trough points, or both should be identified. In some cases, the processor may be limited to searching for peak points, trough points, or both such that user input is not used to determine which types of points to identify. Each determined peak and trough point may be used to create another connecting line such that peak and/or trough points are identified outside of a threshold distance from the new connecting line. In some cases, there may not be a point outside of the threshold distance from the connecting line, and the recursive process may end.

Continuing to 202, the processor provides the determined data points. For example, the process may transmit, store, or display the determined data points.

The processor may connect the determined data points to form an updated trend line. For example, the processor may store the determined peak and/or trough data points found outside of the threshold distance from the connecting line with the original beginning and ending points. The process may create a trend line between these points to create the smoothed data set. The trend line preserves the identified peak and/or trough points such that they may be considered in prediction analysis.

The processor may provide the updated trend line.

In some implementations, the determined data points may be displayed for a user to view. For example, the processor may cause the data to be displayed on a display associated with the processor or may transmit the information via a network to another electronic device for displaying the determined data points or a trend line associated with the determined data points. In some cases, the provided data points may be used in a prediction method to predict the likelihood of a future event. For example, determined data points related to the number of users for a computer system may be used to determine how many users would be likely to be using the computer on a particular day at a particular time.

In one implementation, the processor generates a visual interface for a user to visualize the method. The visual user interface may be displayed on a display device associated with an electronic device including the processor. In some cases, the visual interface may be displayed on a display device remote from the processor where the processor communicates via a network

The visual interface may include any suitable information for smoothing the time series data net while preserving peak and/or trough data points. In one implementation, the visual interface displays information about the time series data set prior to smoothing, such as to assist a user in determining a suitable threshold distance or a beginning and ending point for the smoothing process.

In one implementation, the visual interface receives information about a viewing scale from a user. The scale may be used to alter how the time series data is displayed. For example, the scale may affect how a graph of the time series data is displayed, such as the size of how it is displayed to the user. A user may adjust the scale to better visualize the time series data to assist the user in making decisions about how to smooth the data, such as decisions about selecting a threshold distance.

In one implementation, the visual interface shows the time series data set before and after smoothing. For example, the connecting line and threshold distance may not be visible to the user. In some cases, a user may view the smoothed data and then choose a second threshold distance to provide a different level of smoothing.

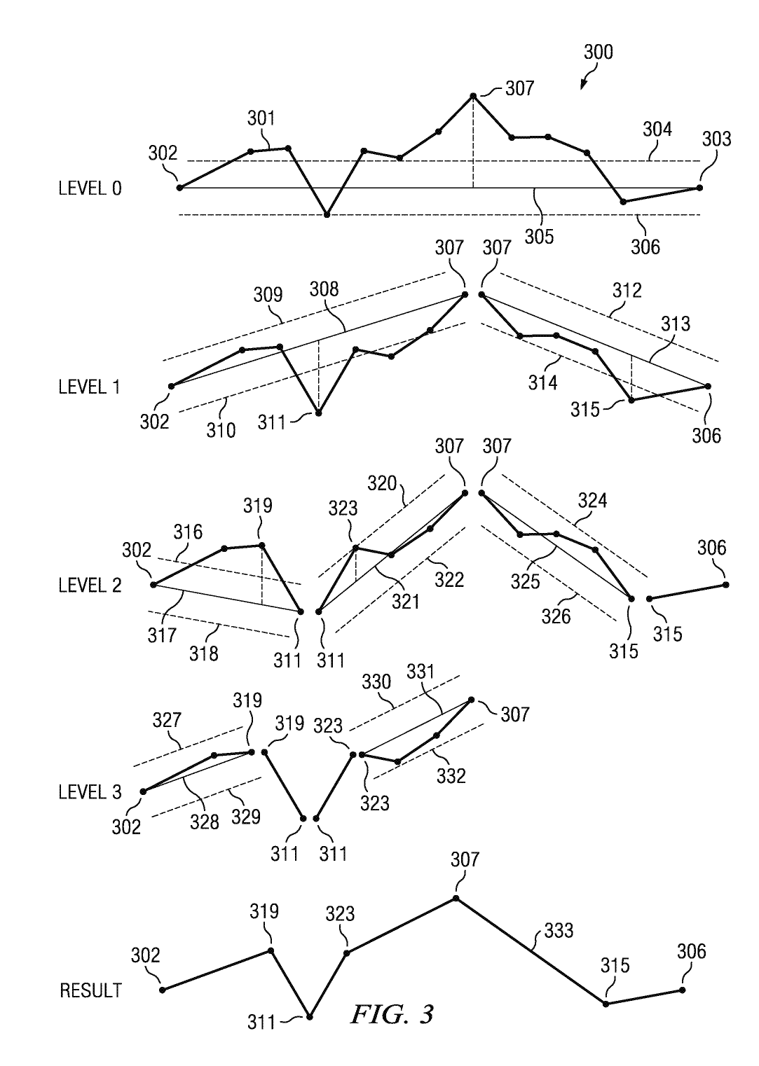

FIG. 3 is a diagram 300 illustrating one example of smoothing a time series data line while preserving peak and trough points. The example shown in FIG. 3 may be implemented, for example, by the processor 101 from FIG. 1. The processor may recursively analyze the time series data set to determine peak and/or trough points that should be preserved when smoothing the time series data set. The degree of smoothing may be determined by a selected threshold distance. The threshold distance may be determined based on user input. The processor may determine whether there is a data point outside of a threshold distance from a line connecting a first and second data point, and the first and second data point may be recursively updated. The diagram 300 shows lines used for making calculations for explanatory purposes. The processor may make the same calculations without displaying the lines shown in the diagram 300.

The diagram 300 includes a time series data set represented by a line 301. The line 301 shows multiple changes of direction in the time series data set. It may be desirable to smooth the time series data set so that it includes fewer changes in direction. A smoother data set may make the time series data set easier to analyze. For example, there may be fewer points to analyze in a prediction algorithm.

The diagram 300 shows multiple levels where each level represents another recursion of the process of smoothing the time series data set line 301. Starting at Level 0, peak and trough points outside of a threshold distance from a connecting line are identified. Beginning and ending points are connected with the connecting line, and threshold lines are created that are the threshold distance above and below the connecting line.

The time series data set line 301 has a beginning point 302 and an ending point 303. The time series data net may be larger where the beginning point 302 and ending point 303 begin and end a selected portion of the time series data set. A connecting line 305 is a straight line connecting the beginning point 302 and ending point 303. Threshold line 304 is a threshold distance above the connecting line 305, and threshold line 306 is a threshold distance below the connecting line 305. Portions of the time series data set line 301 are outside of the threshold lines 304 and 305.

Because there is at least one data point outside of the threshold distance from the connecting line 305, the processor identifies a data point between the beginning data point 302 and the ending data point 303 the greatest distance outside of the threshold distance from the line 305 connecting the beginning data point 302 and the ending data point 303. For example, the point 307 is the peak point outside of the threshold lines 304 and 306. In this case, there are no points below the threshold line 306. In the event that a trough point is found in addition to a peak point, both may be preserved, or one of the trough and peak point may be preserved, such as the point that is farther from the data line or connecting line.

The processor may recursively identify data points between the identified data points. For example, the processor may identify a data point between the beginning data point 302 and the identified peak data point 307 and between the identified peak data point 307 and the ending data point 303. Level 1 shows a first portion with a connecting line 308 connecting the beginning point 302 and the data point 307 and a second portion with a connecting line 313 connecting the data point 307 with the ending data point 306.

Lines 309 and 310 are a threshold distance from the connecting line 308, and point 311 is the lowest point outside of the threshold lines 309 and 310. For the second portion, the threshold lines 312 and 314 are a threshold distance from the connecting line 313. The processor identifies the point 315 as the lowest point outside of the threshold lines 312 and 314 surrounding the connecting line 313, and no points are found above the threshold line 312.

At level 2, the processor analyzes the segments created by the identified points 311 and 315 in level 1. The processor searches for points outside of a threshold distance from a connecting line between points 302 and 311, between points 311 and 307, between points 307 and 315, and between 315 and 303. A connecting line 317 is formed between points 302 and 311 with threshold lines 316 and 318 each a threshold distance from the connecting line 317. A point 319 is identified as a peak point outside of the threshold line 316.

A connecting line 321 connects points 311 and 307, and threshold lines 320 and 322 are each a threshold distance from the connecting line 321. A point 323 is a peak point outside of the threshold line 320. The point 323 is close to the threshold line 323. If a larger threshold distance is selected, the point 323 would not be preserved.

A connecting line 325 connects points 307 and 315. Threshold lines 324 and 326 are a threshold distance from the connecting line 325. No points are found outside of the threshold lines 324 and 326. As a result, the portion of the time series data set between points 307 and 315 is not analyzed further because there are not additional points identified.

The data between the points 315 and 306 forms a straight line. A connecting line is not used because there are no points outside of a threshold distance from a straight line. The portion of the time series data set between points 315 and 306 is not further analyzed to identify additional points for preserving.

At Level 3, the processor searches for a point outside of a threshold distance from a connecting line 328 connecting point 302 and 319. There is no further analysis of the points between points 302 and 319 because there are no points outside of the threshold lines 327 and 329.

The data between point 319 and 311 and between point 311 and 323 each forms a straight line. A connecting line is not created because there are no peak or trough points outside of a threshold distance from a straight line. The portion of the data between points 319 and 311 is not further analyzed.

A connecting line 331 is formed to connect point 323 and 307 with threshold lines 332 and 330 a threshold distance from the connecting line 331. No points are outside of the threshold lines 332 and 330. As a result, the recursive process ends because there are no additional identified points forming segments for analysis.

A resulting smoothed trend line is created where there are no recursions in process because there are no more points outside of threshold lines to be identified. The resulting smoothed trend line includes the beginning data point, the ending data point, and each of the identified peak and trough data points. For example, the resulting trend line 333 includes the beginning point 302, identified points 319, 311, 323, 307, and 315, and ending point 303. The points are connected to form the trend line 333. The trend line 333 is a smoothed version of the data line 301 that preserves peak and trough points outside of a set threshold distance.

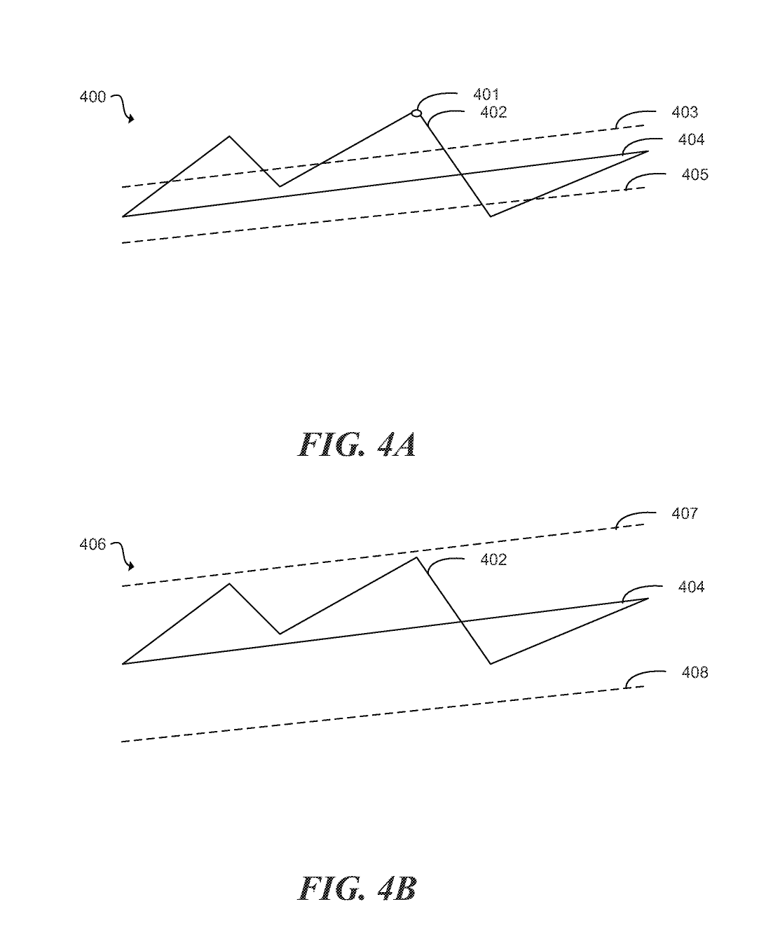

FIGS. 4A and 4B are diagrams illustrating examples of smoothing a time series data line using different threshold distances. The use of different threshold distances results in different smoothed data sets. A smaller threshold distance results in more points being preserved than a larger threshold distance. A user may update the threshold distance, and the process may run again with the updated threshold distance to start a new smoothing process on the time series.

Example 400 in FIG. 4A includes a time series data set 402, and a connecting line 404 is created between the beginning and ending point of the time series data set 402. Threshold lines 403 and 405 are created at a first threshold distance from the connecting line 404. A point 401 is found to be a peak point outside of the threshold line 403.

Example 406 of FIG. 4B shows the time series data line 402 from FIG. 4A and the connecting line 404 connecting the beginning and ending points of the time series data line 402. Example 406 shows a different threshold distance used from the connecting line 404 than in Example 400. The threshold distance in example 406 is larger. As a result, there are no points outside of the threshold lines 407 and 408 that are preserved.

A user may select a different threshold distance based on the desired level of smoothing. For example, a smaller threshold distance may result in more points being preserved and less smoothing. A user may smooth the same time series data set multiple times using different threshold distances to achieve multiple resulting smoothed data sets. A user may input one threshold distance for a first portion of a time series data set and input a second threshold distance for a second portion of a time series data set. For example, it may be desirable to preserve more points for data collected during particular times. In some implementations, a first threshold distance may be used for peak points and a second threshold distance may be used for trough points. For example, in some cases it may be useful to preserve more peak or trough point. In some cases, the process is limited to smoothing peak points or smoothing trough points such that one threshold distance is used or two threshold distances are used where one is set to zero. In some cases, a processor may automatically update a threshold distance. For example, if a user would like the data smoothed to remove a particular percentage of points, the processor may change threshold distance for particular portions of the data set or for particular iterations to achieve the desired result.

Smoothing a time series data set while preserving peak and/or trough points may be useful for analyzing the time series information. For example, some prediction methods may arrive at an undesirable prediction if past data at particular extremes are ignored. A smoothed data not that preserves peak and/or trough points may be useful for smoothing time series data associated with an information technology system.

1. A method, comprising:
identifying, by a processor, at least one of a peak or trough data point outside of a user determined threshold distance from a line connecting a first data point and a second data point of a time series data set;
identifying at least one of a peak or trough data point outside of the threshold distance from a line connecting the first data point and the identified point;
identifying at least one of a peak or trough data point outside of the threshold distance from a line connecting the identified point and the second data point; and
providing each identified data point.

2. The method of claim 1, further comprising updating the threshold distance.

3. The method of claim 1, further comprising: causing the time series data set to be displayed based on a scale selected by user input.

4. The method of claim 1, further comprising using the created identified data points to predict a future event.

5. The method of claim 1, wherein providing the identified data points comprises causing a trend line connecting the identified data points to be displayed.

6. An apparatus, comprising:
a processor to:
determine at least one of peak or trough data points in a time series data set beyond a threshold distance from a connecting line between a beginning and ending data point, wherein the determination is repeated with an updated beginning and ending data point based on the determined data points; and
provide the determined points.

7. The apparatus of claim 6, wherein determining data points comprises:
determining at least one of a peak or trough data point beyond a threshold distance from the connecting line between the beginning and ending data point;
determining at least one of a peak or trough data point beyond a threshold distance from a connecting line between the beginning data point and the determined data point; and
determining at least one of a peak or trough data point beyond a threshold distance from a connecting line between the determined data point and the ending data point.

8. The apparatus of claim 6, wherein the processor further displays the time series data set on a scale selected by user input.

9. The apparatus of claim 6, wherein the processor further performs a prediction method on the updated data point line.

10. The apparatus of claim 6, wherein the processor further sets the threshold distance based on user input.

11. A machine-readable non-transitory storage medium comprising instructions executable by a processor to:
smooth a time series data set to remove noise while preserving at least one of peak and trough data points within the data set outside a threshold distance from a line connecting the data points; and
provide the smoothed time series data set.

12. The machine-readable non-transitory storage medium of claim 11, wherein instructions to smooth a time series data set comprises instructions to repeatedly perform a step to identify at least one of a peak or trough data point outside of a threshold distance of a connecting line connecting a beginning point and an ending point where the connecting line is updated with each repeated step.

13. The machine-readable non-transitory storage medium of claim 11, further comprising instructions to use the smoothed time series data set for predicting the likelihood of a future information technology event.

14. The machine-readable non-transitory storage medium of claim 11, further comprising instructions to update the threshold distance based on user input.

15. The machine-readable non-transitory storage medium of claim 14, further comprising instructions to provide a visual interface for displaying changes in the smoothed time series data set in response to changes in the threshold distance.
